(19) United States
(12) Patent Application Publication
(10) Pub. No.: US 2008/0217867 A1
(43) Pub. Date: Sep. 11, 2008

(54) Sealing Structure of Casing

(75) Inventors: Yosuke Kato, Aichi-ken (JP); Yota Mizuno, Aichi-ken (JP); Kenji Tanabe, Aichi-ken (JP); Hiroshi Hata, Aichi-ken (JP); Toshiharu Hirai, Aichi-ken (JP); Toshihiko Ishida, Aichi-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi, Aichi-ken (JP)

(21) Appl. No.: 11/991,959

(22) PCT Filed: Sep. 20, 2006
(86) PCT No.: PCT/JP2006/319099

§ 371 Date: Mar. 13, 2008

(30) Foreign Application Priority Data
Oct. 7, 2005 (JP) 2005-295212

(51) Int. Cl. F16J 15/06

(52) U.S. Cl. 277/628

(57) ABSTRACT

A sealing structure of a casing includes a housing having a flow path, a case having a flow path communicating with the flow path when combined with the housing, a tubular knock pin provided to fit to both of the housing and the case and surround the flow path in a joint portion between the housing and the case, and an FIPG holding portion provided on an outer circumferential side of the knock pin.

### TECHNICAL FIELD

The present invention relates to a sealing structure of a casing, and more particularly to a sealing structure of a casing sealing a flow path that passes by a joint portion between first and second case forming members.

### BACKGROUND ART

A casing formed from combination of a plurality of case forming members has conventionally been known.

For example, Japanese Patent Laying-Open No. 2004-116735 (Patent Document 1) discloses a drive apparatus, in which a passage through which a fluid passes is formed in each of divided cases and the passages formed in respective cases communicate with each other when the cases are combined.

In addition, Japanese Patent Laying-Open No. 2003-166407 (Patent Document 2) discloses a cover positioning structure in which a hollow knock pin for positioning is press-fitted to an oil discharge hole and an oil supply path across joint surfaces of an oil pump body and an oil pump cover.

In an example where flow paths provided in respective casings communicate with each other as a result of combination of a plurality of casings as in Patent Document 1, a sealing portion suppressing leakage of a fluid should be provided at the joint surfaces of the casings.

Where the sealing portion is provided at a position exposed to the flow path, however, the sealing portion is carried away by the flow of the fluid and sealing characteristics may be lowered.

In addition, as sealing is achieved only with the hollow knock pin in Patent Document 2, sealing characteristics are not sufficiently ensured.

### DISCLOSURE OF THE INVENTION

An object of the present invention is to provide a sealing structure of a casing attaining high sealing characteristics.

A sealing structure of a casing according to the present invention includes: a first case forming member having a first fluid path; a second case forming member having a second fluid path communicating with the first fluid path when combined with the first case forming member; a tubular member provided to fit to the first and second case forming members and surround the first and second fluid paths at a joint portion between the first and second case forming members; and a sealing portion provided on an outer circumferential side of the tubular member.

According to the structure above, as the sealing portion is provided on the outer circumferential side of the tubular member, the sealing portion is not exposed to the fluid that flows through the fluid path and carrying away of the sealing portion by the flow of the fluid can be suppressed. Consequently, lowering in the sealing characteristics can be suppressed.

In the sealing structure of the casing above, preferably, the tubular member includes a member fitted to both of the first and second case forming members.

According to the structure above, as the tubular member is fitted to both of the first and second case forming members, the tubular member can serve as the knock pin. Therefore, the number of holes for providing the knock pin can be decreased. Consequently, manufacturing cost can be reduced.

In the sealing structure of the casing above, preferably, the sealing portion is provided in contact with an outer circumferential surface of the tubular member.

According to the structure above, the sealing portion is held between the tubular member and the case forming member. Therefore, working for forming a space for the sealing portion can be simplified and manufacturing cost can further be reduced.

In the sealing structure of the casing above, preferably, a recess portion is formed as a result of back-off of at least one of joint surfaces of the first and second case forming members at a position adjacent to the outer circumferential surface of the tubular member, and the sealing portion is provided in the recess portion.

According to the structure above, the recess portion can be formed only by working a corner portion of the case forming member. In addition, the sealing structure of the casing can be implemented by providing the sealing portion only at a single location. Consequently, manufacturing cost can be reduced.

In the sealing structure of the casing above, preferably, the sealing portion includes an O-ring or a liquid gasket. Thus, high sealing characteristics can be obtained while achieving reduced manufacturing cost.

In the sealing structure of the casing above, preferably, the sealing portion includes first and second sealing members provided between the first and second case forming members and the tubular member, respectively.

According to the structure above, characteristics to follow spread between joint surfaces of the first and second case forming members can be improved. Consequently, the sealing structure with high sealing characteristics can be obtained.

In the sealing structure of the casing above, preferably, a portion receiving the tubular member in the first and second case forming members has an inner diameter larger than an outer diameter of the tubular member, and total depth of the portion receiving the tubular member in the first and second case forming members is greater than an axial length of the tubular member.

According to the structure above, even when the first and second case forming members move relative to each other, movement of the tubular member is permitted. Therefore, high sealing characteristics are ensured.

In the sealing structure of the casing above, in one aspect, the tubular member or the sealing portion swells as a result of contact with a fluid that flows through the first and second fluid paths. Alternatively, in another aspect, the tubular member expands the sealing portion in a radial direction as a result of being fitted inside of the sealing portion.

According to the structure above, the sealing structure with high sealing characteristics can be obtained while suppressing increase in cost.

According to the present invention, as described above, a sealing structure of a casing attaining high sealing characteristics can be obtained, while achieving reduced manufacturing cost.

### BRIEF DESCRIPTION OF THE DRAWINGS

FIG. 1 is a cross-sectional view of a powertrain to which a sealing structure of a casing according to a first embodiment of the present invention is applied.

FIG. 2 illustrates a detailed structure of a portion A of the powertrain shown in FIG. 1.

FIG. 3 is a cross-sectional view showing the sealing structure of the casing according to the first embodiment of the present invention.

FIG. 4 is a cross-sectional view showing a variation of the sealing structure of the casing according to the first embodiment of the present invention.

FIG. 5 is a cross-sectional view showing another variation of the sealing structure of the casing according to the first embodiment of the present invention.

FIG. 6 is a cross-sectional view showing yet another variation of the sealing structure of the casing according to the first embodiment of the present invention.

FIG. 7 is a cross-sectional view showing yet another variation of the sealing structure of the casing according to the first embodiment of the present invention.

FIG. 8 is a cross-sectional view showing yet another variation of the sealing structure of the casing according to the first embodiment of the present invention.

FIG. 9 is a cross-sectional view showing yet another variation of the sealing structure of the casing according to the first embodiment of the present invention.

FIG. 10 is a cross-sectional view showing yet another variation of the sealing structure of the casing according to the first embodiment of the present invention.

FIG. 11 is a cross-sectional view showing yet another variation of the sealing structure of the casing according to the first embodiment of the present invention.

FIG. 12 is a cross-sectional view showing yet another variation of the sealing structure of the casing according to the first embodiment of the present invention.

FIG. 13 is a cross-sectional view showing yet another variation of the sealing structure of the casing according to the first embodiment of the present invention.

FIG. 14 is a cross-sectional view showing yet another variation of the sealing structure of the casing according to the first embodiment of the present invention.

FIG. 15 is a cross-sectional view showing a sealing structure of a casing according to a reference example 1.

FIG. 16 is a cross-sectional view showing a sealing structure of a casing according to a reference example 2.

FIG. 17 is a cross-sectional view of a powertrain to which a sealing structure of a casing according to a second embodiment of the present invention is applied.

FIG. 18 is a cross-sectional view showing the sealing structure of the casing according to the second embodiment of the present invention.

FIG. 19 is a cross-sectional view showing a sealing structure of a casing according to a third embodiment of the present invention.

FIG. 20 is a cross-sectional view showing a variation of the sealing structure of the casing according to the third embodiment of the present invention.

FIG. 21 is a cross-sectional view showing another variation of the sealing structure of the casing according to the third embodiment of the present invention.

FIG. 22 illustrates a mechanism that a barrel-shaped member expands a sealing member in the structure shown in FIG. 21.

FIG. 23 is a cross-sectional view showing yet another variation of the sealing structure of the casing according to the third embodiment of the present invention.

FIG. 24 is a cross-sectional view showing yet another variation of the sealing structure of the casing according to the third embodiment of the present invention.

### BEST MODES FOR CARRYING OUT THE INVENTION

An embodiment of a sealing structure of a casing according to the present invention will be described hereinafter. The same or corresponding elements have the same reference characters allotted, and description thereof may not be repeated.

### First Embodiment

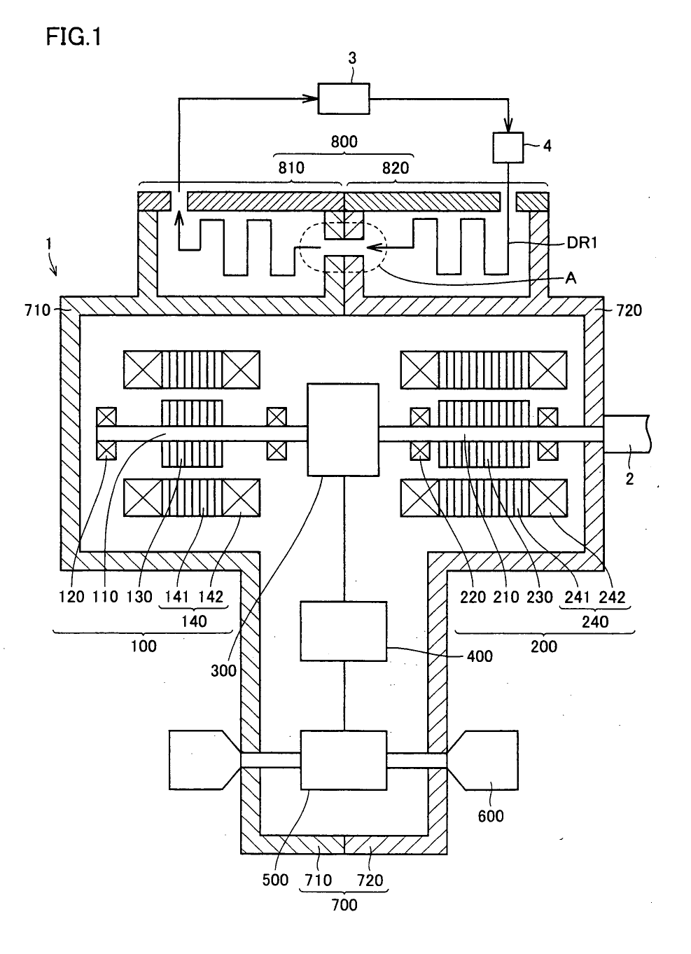

FIG. 1 is a cross-sectional view of a powertrain to which a sealing structure of a casing according to a first embodiment of the present invention is applied.

Referring to FIG. 1, a drive unit 1 serving as a powertrain mounted on a hybrid vehicle includes rotating electric machines 100, 200, a planetary gear mechanism 300, a reduction mechanism 400, a differential mechanism 500, and a drive shaft receiving portion 600. Rotating electric machines 100, 200, planetary gear mechanism 300, reduction mechanism 400, and differential mechanism 500 are provided within a casing 700.

Rotating electric machines 100, 200 are motor-generators having a function as a motor or a generator. Rotating electric machines 100, 200 include rotation shafts 110, 210 rotatably attached to casing 700 via bearings 120, 220 respectively, rotors 130, 230 attached to rotation shafts 110, 210 respectively, and stators 140, 240, respectively.

Each of rotors 130, 230 has a rotor core and a magnet embedded in the rotor core. The rotor core is formed by layering plate-shaped magnetic elements made of iron, iron alloy or the like. For example, the magnets are arranged at substantially regular intervals in the vicinity of an outer circumference of the rotor core.

Stators 140, 240 have ring-shaped stator cores 141, 241 and stator coils 142, 242 wound around stator cores 141, 241, respectively, and stator coils 142, 242 are electrically connected to a battery via a cable.

Stator core 141, 241 is formed by layering plate-shaped magnetic elements made of iron, iron alloy or the like. A plurality of tooth portions (not shown) and slot portions (not shown) serving as a recess portion formed between the tooth portions are formed on an inner circumferential surface of stator core 141, 241. The slot portion is provided to open toward the inner circumferential side of stator core 141, 241.

Stator coil 142, 242 including U-phase, V-phase and W-phase representing three winding phases is wound around the tooth portions in a manner fitted to the slot portions. The U-phase, the V-phase and the W-phase of coil 142, 242 are wound such that they are displaced from each other on a circumference.

Planetary gear mechanism 300 is implemented, for example, by a plurality of planetary gears, and has a power split function and a reduction function. Here, the ring gear in the plurality of planetary gears may be implemented by a single tubular member.

During operation of drive unit 1, motive power output from an engine (not shown) is transmitted to a shaft 2 and split into two paths by planetary gear mechanism 300.

One of the two paths above is a path from reduction mechanism 400 through differential mechanism 500 to drive shaft receiving portion 600. Driving force transmitted to drive shaft receiving portion 600 is in turn transmitted as rotational force to wheels (not shown) via a drive shaft (not shown), to run the vehicle.

Another one of the paths is a path for driving rotating electric machine 100 to generate electric power. Rotating electric machine 100 generates electric power by receiving motive power of the engine distributed by planetary gear mechanism 300. Electric power generated by rotating electric machine 100 is used depending on a running state of the vehicle or a state of a battery (not shown). For example, during normal running of the vehicle and sudden acceleration, electric power generated by rotating electric machine 100 serves as it is as electric power driving rotating electric machine 200. On the other hand, under a condition determined in the battery, electric power generated by rotating electric machine 100 is stored in the battery via not-shown inverter and converter.

Rotating electric machine 200 is driven by at least one of electric power stored in the battery and electric power generated by rotating electric machine 100. Driving force of rotating electric machine 200 is transmitted from reduction mechanism 400 through differential mechanism 500 to drive shaft receiving portion 600. By doing so, driving force from the rotating electric machine can assist driving force of the engine, or the vehicle can run only with driving force from rotating electric machine 200.

On the other hand, during regenerative braking of the hybrid vehicle, the wheels rotate based on inertial force of the vehicle body. Rotating electric machine 200 is driven by rotational force from the wheels via drive shaft receiving portion 600, differential mechanism 500 and reduction mechanism 400. Here, rotating electric machine 200 operates as the generator. Rotating electric machine 200 thus serves as a regenerative brake converting braking energy to electric power. Electric power generated by rotating electric machine 200 is stored in the battery via the inverter.

In drive unit 1 thus configured, rotating electric machine 100, 200 generates heat during generation of driving force and generation of electric power. In addition, heat is generated also in planetary gear mechanism 300 as a result of driving. Heat generated in rotating electric machine 100, 200 or planetary gear mechanism 300 is dissipated to casing 700 via oil or the like. Here, if heat dissipation from casing 700 is not appropriately achieved, components in drive unit 1 within casing 700 are affected by the heat. In order to address this, a water jacket 800 serving as a “cooling device” is provided in casing 700. By partitioning an internal space of water jacket 800, a cooling medium passage for passing a cooling medium is formed. The cooling medium within the cooling medium passage is circulated by a pump 4 via a radiator 3. Rotating electric machine 100, 200 is thus cooled via casing 700. For example, an LLC (Long Life Coolant) is used as the cooling medium, and a coolant water, an anti-freeze and the like can also be used.

A rotating electric machine attaining higher output than rotating electric machine 100 that generates electric power mainly based on motive power from the engine is employed as rotating electric machine 200 generating driving force for mainly running the vehicle. Accordingly, an amount of heat generation in rotating electric machine 200 is greater than that in rotating electric machine 100. Therefore, in drive unit 1, the cooling medium passage is set such that the cooling medium flows from rotating electric machine 200 toward rotating electric machine 100 (direction shown with an arrow DR1).

In drive unit 1, rotating electric machines 100, 200 are accommodated in a housing 710 and a case 720 that are separate casings, respectively. Water jacket 800 includes a first portion 810 located on rotating electric machine 100 side and a second portion 820 located on rotating electric machine 200 side. The side surface of first portion 810 of water jacket 800 is formed integrally with housing 710, and the side surface of second portion 820 of water jacket 800 is formed integrally with case 720. First and second portions 810, 820 are provided with openings serving as the cooling medium passages. By combining housing 710 and case 720 with each other, the cooling medium passage in first portion 810 and the cooling medium passage in second portion 820 communicate with each other.

As shown in FIG. 1, the cooling medium passes by the joint surfaces of housing 710 (first portion 810 of water jacket 800) and case 720 (second portion 820 of water jacket 800). Therefore, a sealing structure suppressing leakage of the cooling medium from between the joint surfaces of housing 710 and case 720 should be provided.

FIGS. 15 and 16 are cross-sectional views showing sealing structures of casings according to reference examples 1 and 2 respectively.

Referring to FIG. 15, in reference example 1, joint surfaces of a housing 710A and a case 720A forming a casing 700A are sealed with an FIPG (Formed In Place Gasket). An FIPG holding portion 740A is thus formed and leakage of the cooling medium is suppressed. In the example in FIG. 15, however, as FIPG holding portion 740A is exposed to the cooling medium, FIPG holding portion 740A is likely to break and flow away due to the flow of the cooling medium. Carrying away of FIPG holding portion 740A results in lower sealing characteristics of the FIPG.

Referring to FIG. 16, in reference example 2, the joint surfaces of a housing 710B and a case 720B forming a casing 700B are sealed with an O-ring 750B. In this case, however, as the surface of the housing should be worked in order to form a groove portion for O-ring 750B, productivity is lowered and cost increases.

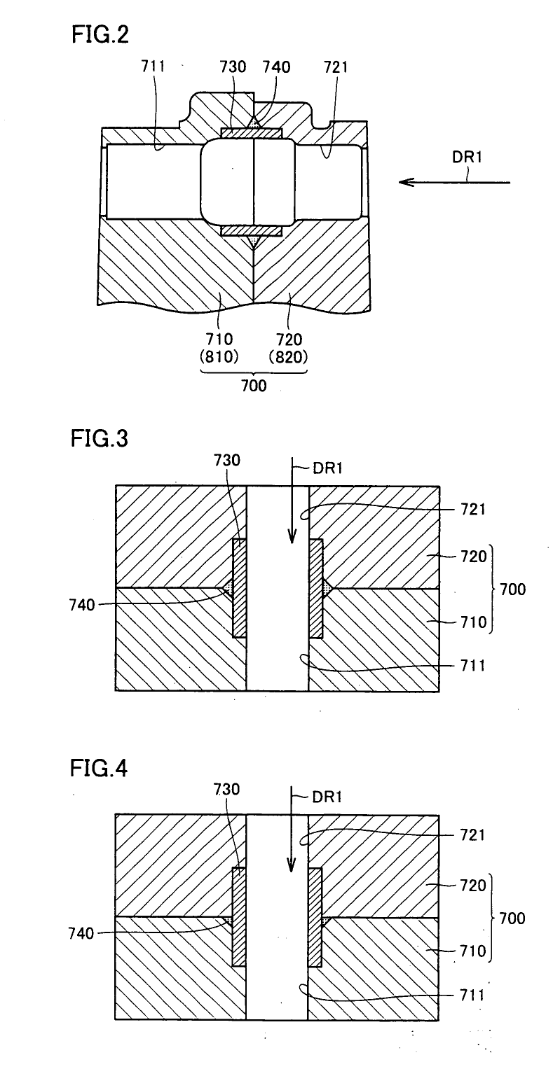

The sealing structure of the casing according to the present embodiment will be described hereinafter. FIG. 2 illustrates a detailed structure of a portion A in FIG. 1. In addition, FIG. 3 is a cross-sectional view showing the sealing structure of the casing according to the present embodiment and schematically shows the structure shown in FIG. 2. Referring to FIGS. 2 and 3, a flow path 711 is formed in housing 710 forming first portion 810 of the water jacket, and a flow path 721 is formed in case 720 forming second portion 820 of the water jacket. By combining housing 710 and case 720 with each other, flow paths 711 and 721 communicate with each other. Thus, the coolant passage within first portion 810 of water jacket 800 and the coolant passage within second portion 820 communicate with each other. A knock pin 730 having a cylindrical shape is provided at the joint surfaces of housing 710 and case 720. FIPG holding portion 740 is provided on the outer circumferential surface of knock pin 730. FIPG holding portion 740 is provided in a recess portion formed by beveled corner portions of the joint surfaces of housing 710 and case 720.

As described above, by providing FIPG holding portion 740 on the outer circumference of knock pin 730, FIPG holding portion 740 is not exposed to the flow of the cooling medium and carrying away of FIPG holding portion 740 can be suppressed. Consequently, lowering in the sealing characteristics can be suppressed. In addition, as beveling for forming a space for FIPG holding portion 740 can be performed more easily than forming a groove portion, increase in the cost is suppressed. Moreover, as knock pin 730 can be utilized as positioning means at the time of assembly of housing 710 and case 720, the number of knock pins can be decreased. Consequently, the number of parts can be decreased and the cost can be reduced.

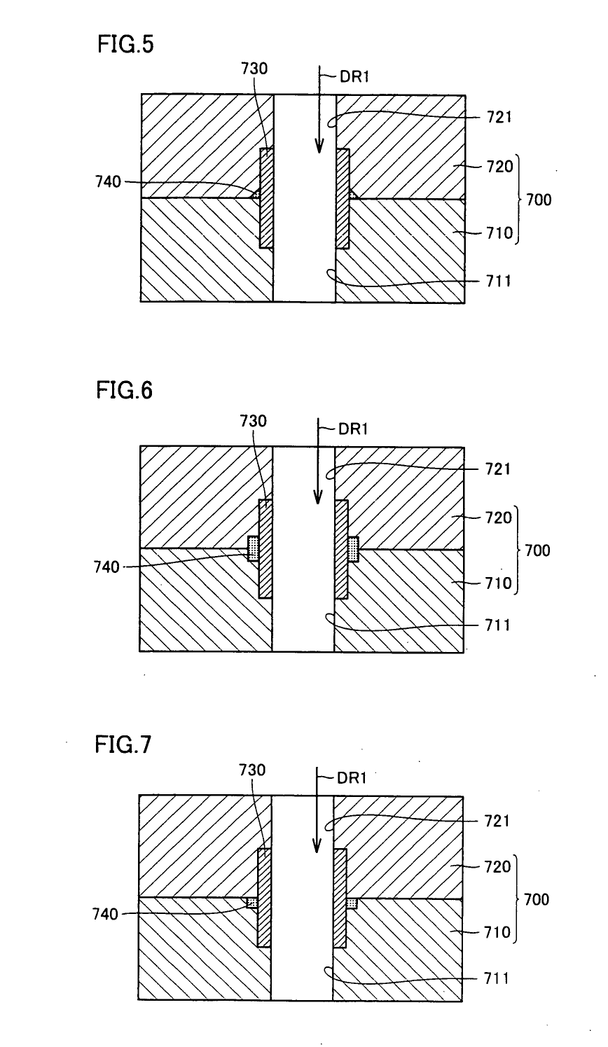

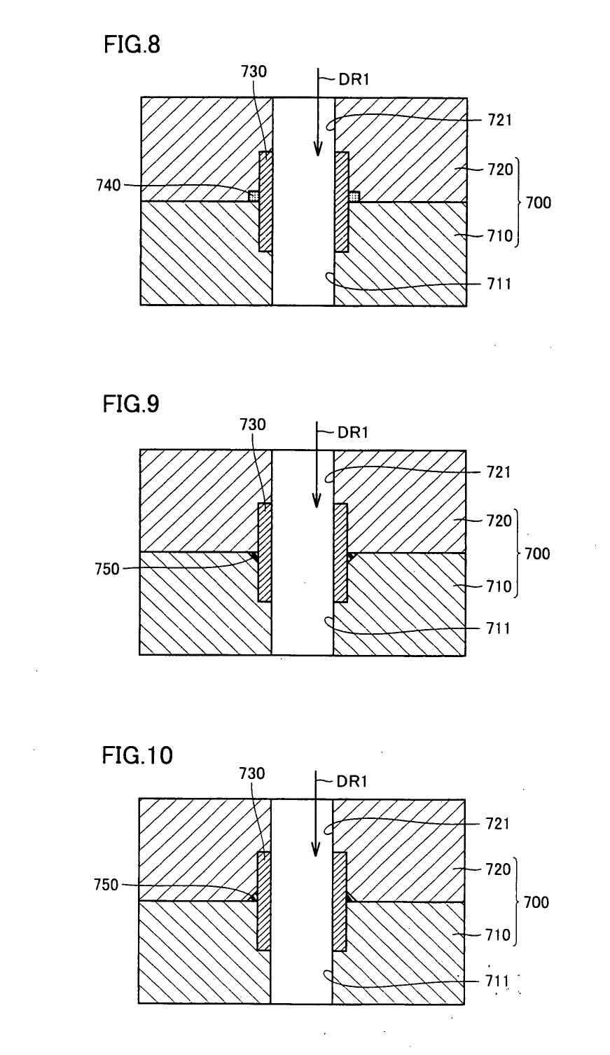

FIGS. 4 to 14 are diagrams showing variations of the sealing structure above. As shown in FIGS. 4 and 5, beveling for forming a space (recess portion) for providing FIPG holding portion 740 may be performed in only one of housing 710 and case 720. Alternatively, as shown in FIG. 6, FIPG holding portion 740 may be provided in a recess portion formed by counter-boring corner portions of the joint surfaces of housing 710 and case 720. Alternatively, as shown in FIGS. 7 and 8, only one of housing 710 and case 720 may be counter-bored.

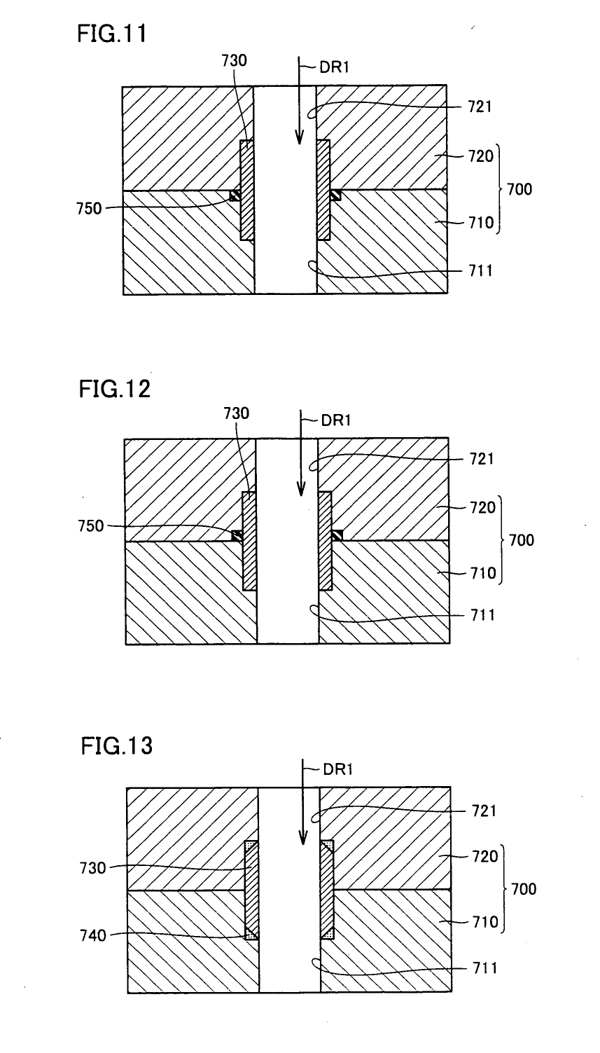

In the examples shown in FIGS. 9 to 12, O-ring 750 is provided instead of FIPG holding portion 740. For example, O-ring 750 is provided in a recess portion formed by beveling housing 710 in FIG. 9, O-ring 750 is provided in a recess portion formed by beveling case 720 in FIG. 10, O-ring 750 is provided in a recess portion formed by counter-boring housing 710 in FIG. 11, and O-ring 750 is provided in a recess portion formed by counter-boring case 720 in FIG. 12.

In the examples shown in FIGS. 2 to 12, FIPG holding portion 740 or O-ring 750 is provided in a recess portion formed as a result of back-off of at least one of the joint surfaces of housing 710 and case 720 at a position adjacent to the outer circumferential surface of knock pin 730. In other words, in the examples shown in FIGS. 2 to 12, FIPG holding portion 740 and O-ring 750 are provided such that they come in contact with the outer circumferential surface of knock pin 730 at a joint portion between housing 710 and case 720. For example, though the outer circumferential surface of knock pin 730 and O-ring 750 may be provided at a distance from each other at the joint portion between housing 710 and case 720, in such a case, working for providing a groove portion in the joint surface of housing 710 or case 720 should be performed. In contrast, in the examples shown in FIGS. 2 to 12, a recess portion for providing FIPG holding portion 740/O-ring 750 can be formed simply by cutting a corner portion of housing 710/case 720. As working of housing 710/case 720 is thus simplified, manufacturing cost can be reduced.

In addition, in the examples shown in FIGS. 2 to 12, the sealing structure can be formed by providing FIPG holding portion 740 or O-ring 750 at one location. Consequently, increase in manufacturing cost can be suppressed.

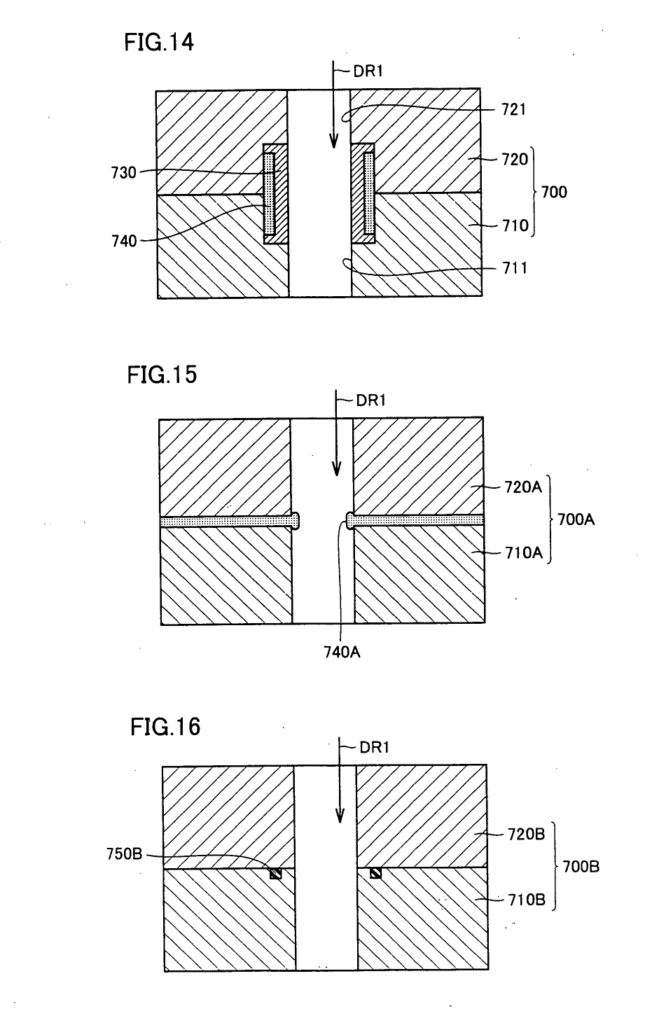

As shown in FIG. 13, knock pin 730 may be worked for forming a space for providing FIPG holding portion 740 (or O-ring 750). The example as in FIG. 13 should also be interpreted as FIPG holding portion 740 being provided in a manner in contact with the outer circumferential surface of knock pin 730. In addition, as shown in FIG. 14, FIPG holding portion 740 may be provided over substantially the entire axial length of knock pin 730.

The description above is summarized as follows. Namely, the sealing structure of the casing according to the present embodiment includes housing 710 serving as the “first case forming member” having flow path 711 serving as the “first fluid path,” case 720 serving as the “second case forming member” having flow path 721 serving as the “second fluid path” communicating with flow path 711 when combined with housing 710, knock pin 730 serving as the “tubular member” provided to fit to both of housing 710 and case 720 and surround flow paths 711, 721 at the joint portion between housing 710 and case 720, and FIPG holding portion 740 or O-ring 750 serving as the “sealing portion” provided on the outer circumferential side of knock pin 730.

According to the structure above, knock pin 730 can be utilized as positioning means at the time of assembly of housing 710 and case 720. Consequently, the number of man-hours in working casing 700 for providing the knock pin can be decreased and manufacturing cost can be reduced. In addition, as the “sealing portion” is provided on the outer circumferential side of knock pin 730, the “sealing portion” is not exposed to a fluid that flows through flow path 711, 721 and carrying away of the “sealing portion” by the flow of the fluid can be suppressed. Consequently, lowering in the sealing characteristics can be suppressed. In addition, by implementing the “sealing portion” with the O-ring or the liquid gasket (FIPG), manufacturing cost can further be reduced.

It is noted that the shape of knock pin 730 is not limited to a cylindrical shape, and for example, it may be in a hollow prismatic shape having a polygonal cross-section in the axial direction.

In addition, the sealing structure of the casing described above is applicable not only to drive unit 1 but also to any casing, so long as it includes flow paths communicating with each other.

### Second Embodiment

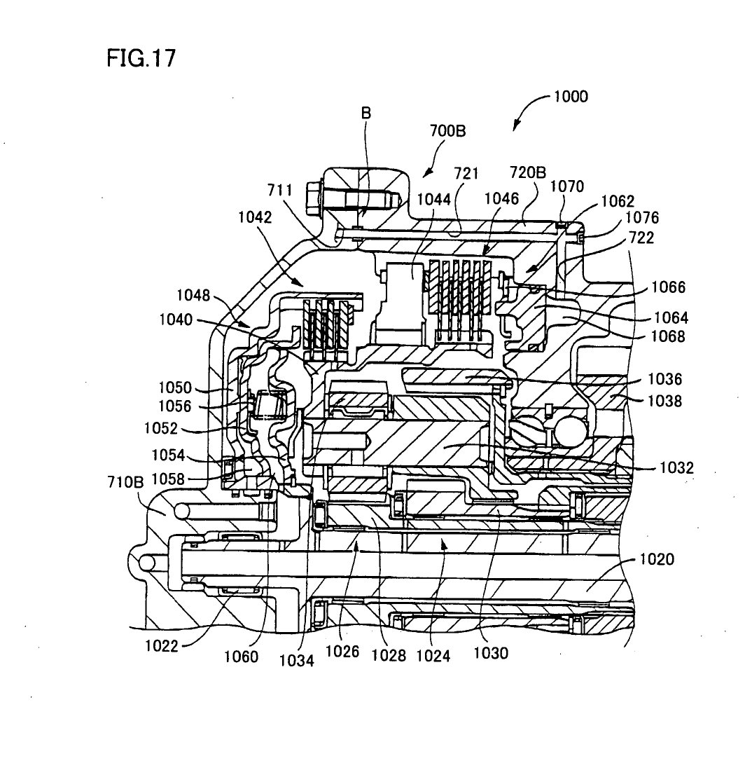

FIG. 17 is a cross-sectional view of a powertrain to which a sealing structure of a casing according to a second embodiment is applied. Referring to FIG. 17, the powertrain according to the present embodiment is an automatic transmission 1000 mounted on a vehicle. Casing 700B accommodating each apparatus of automatic transmission 1000 is divided into a lid-like case 710B serving as the “first case forming member” and a tubular case 720B serving as the “second case forming member.” Lid-like case 710B and tubular case 720B have flange portions projecting in a radially outward direction from lid-like case 710B and tubular case 720B respectively while end surfaces thereof are brought in intimate contact with each other. By fixing the flange portions of lid-like case 710B and tubular case 720B to each other by means of a bolt, tubular case 720B and lid-like case 710B are fixed to each other, to thereby implement casing 700B.

A rotation shaft 1020 is arranged in a central portion of automatic transmission 1000. Rotation shaft 1020 is supported by a bearing 1022 provided in lid-like case 710B, in a manner rotatable with respect to casing 700B. It is noted that motive power of the not-shown engine is transmitted to rotation shaft 1020 via a torque converter. Thus, rotation shaft 1020 is constantly driven to rotate.

Planetary gears 1024, 1026 are arranged side by side in the axial direction, on the outer circumferential side of rotation shaft 1020. Planetary gears 1024, 1026 implement what is called a Ravigneaux gear train in which the ring gear and the planetary carrier being integrated.

Planetary gear 1024 is a single pinion type planetary gear. Planetary gear 1026 is a double pinion type planetary gear. On the outer circumferential side of rotation shaft 1020, a sun gear 1028 of planetary gear 1026 is supported relatively rotatable with respect to rotation shaft 1020, with a plurality of bushes being interposed. In addition, on the outer circumferential side of sun gear 1028, a sun gear 1030 of planetary gear 1024 is supported relatively rotatable with respect to rotation shaft 1020 and sun gear 1028, with a plurality of bushes being interposed. Sun gears 1028, 1030 are engaged with a pinion gear rotatably supported by a common carrier pin 1032. In FIG. 17, one pinion gear 1034 in pinion gear 1026 which is a double pinion type pinion gear is shown, and not-shown the other pinion gear functions as a pinion gear common to pinion gear 1024. Not-shown the other pinion gear is engaged with a ring gear 1036 and output of ring gear 1036 is transmitted to an output gear wheel 1038.

At the end portion on lid-like case 710B side of carrier pin 1032, a hub member 1040 having an outer circumferential portion formed in a cylindrical shape is connected by press-fitting. A friction engagement element 1042, a one-way clutch 1044 and a friction engagement apparatus 1046 are arranged in a manner aligned in the axial direction from lid-like case 710B side of a cylindrical portion located on the outer circumferential side of hub member 1040.

Friction engagement element 1042 is included in a clutch apparatus 1048 selectively transmitting rotation of rotation shaft 1020 to hub member 1040. Clutch apparatus 1048 has a clutch drum 1050 connected to friction engagement element 1042 and rotation shaft 1020 and caused to rotate together, to which one friction plate of friction engagement element 1042 is spline-fitted at the outer circumferential portion, a clutch piston 1052 arranged in a manner covered with clutch drum 1050 and pressing friction engagement element 1042 as a result of its movement forward by a hydraulic pressure, a partition wall 1054 arranged between clutch piston 1052 and hub member 1040, of which inner circumferential portion is prevented from moving in the axial direction by means of a snap ring, and a spring 1056 interposed between clutch piston 1052 and partition wall 1054 and biasing clutch piston 1052 toward clutch drum 1050.

In addition, a hydraulic pressure chamber 1058 which is an oiltight space is formed between clutch drum 1050 and clutch piston 1052. On the other hand, a centrifugal hydraulic pressure canceller chamber 1060 for canceling thrust of clutch piston 1052 based on a centrifugal hydraulic pressure generated in hydraulic pressure chamber 1058 is formed. When the hydraulic pressure is supplied to hydraulic pressure chamber 1058, clutch piston 1052 is moved forward to friction engagement element 1042 side against biasing force of spring 1056, so that friction engagement element 1042 is pressed and friction engagement element 1042 is engaged. Thus, rotation of clutch drum 1050, that is, rotation of rotation shaft 1020, is transmitted to hub member 1040.

One-way clutch 1046 serves to restrict rotation hub member 1040 in one direction. One-way clutch 1046 has an outer race arranged on the outer circumferential side and spline-fitted to tubular case 720B in a manner not rotatable relative to each other, an inner race arranged in the inner circumferential side and fixed to hub member 1040, and a sprag interposed between the outer race and the inner race. Here, the sprag prevents rotation in one direction.

Friction engagement element 1046 is a component member of a brake apparatus 1062 for selectively stopping rotation of hub member 1040. Brake apparatus 1062 has friction engagement element 1046, a brake piston 1064, a spring support plate 1066 fixed to tubular case 720B, and a not-shown spring interposed between brake piston 1064 and spring support plate 1066 and biasing brake piston 1064 away from friction engagement element 1046. In addition, a hydraulic pressure chamber 1068 is formed between brake piston 1064 and tubular case 720B. When a hydraulic pressure is supplied to hydraulic pressure chamber 1068, brake piston 1064 is moved forward to friction engagement element 1046 side by the hydraulic pressure against biasing force of the not shown spring, so that friction engagement element 1046 is engaged and rotation of hub member 1040 is stopped.

Here, a hydraulic oil is supplied to hydraulic pressure chamber 1068 through flow path 711 serving as the “first fluid path” formed in lid-like case 710B, flow path 721 serving as the “second fluid path” formed in tubular case 720B in the axial direction and connected to flow path 711, and a flow path 722 formed in tubular case 720B in a radial direction and connected to flow path 721. It is noted that an oil passage 711 communicates with a hydraulic oil supply hole that communicates with a not-shown valve body. Flow paths 721, 722 (oil passages) formed in tubular case 720B are formed to penetrate a part of tubular case 720B and an opening formed on an outer wall side of tubular case 720B is hermetically sealed by a hermetic seal member 1070.

In addition, flow path 711 formed in lid-like case 710B and flow path 721 formed in tubular case 720B communicate with each other by fastening the flange portions of lid-like case 710B and tubular case 720B to each other by means of a bolt while the end surfaces of lid-like case 710B and tubular case 720B are brought in intimate contact with each other.

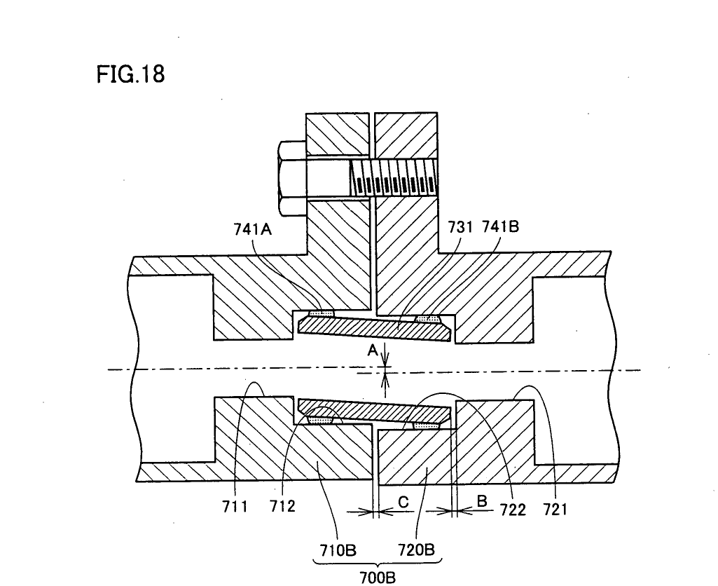

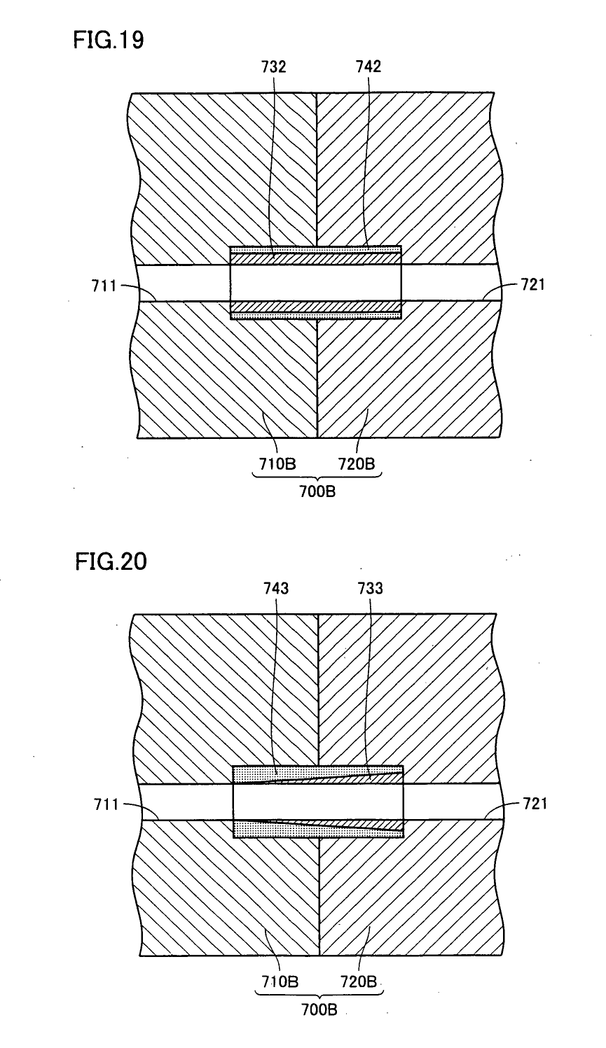

FIG. 18 is a cross-sectional view of the sealing structure of the casing (portion B in FIG. 17) according to the present embodiment. Referring to FIG. 18, an opening 712 of flow path 711 formed in lid-like case 710B and an opening 722 of flow path 721 formed in tubular case 720B are greater in diameter than flow paths 711, 721. Openings 712 and 722 are formed, for example, by counter-boring. A cylindrical member 731 is inserted in openings 712, 722. Cylindrical member 731 is formed, for example, of a metal material such as iron and copper, and a relatively hard elastic material such as a synthetic resin. Cylindrical member 731 is provided in a manner spanning lid-like case 710B and tubular case 720B.

A gap is formed between an inner circumferential surface of openings 712, 722 and an outer circumferential surface of cylindrical member 731. In addition, the diameter of the inner circumference of cylindrical member 731 is formed as large as or greater than the diameter of flow paths 711, 721. Moreover, the total distance in the axial direction between the bottom surface of opening 712 and the bottom surface of opening 722, namely, the total depth of openings 712, 722, is longer than the length in the axial direction (axial length) of cylindrical member 731. Therefore, cylindrical member 731 is movable in the axial direction, and when axis displacement (A) in a radial direction of flow paths 711, 721 occurs, a movement-accommodating-gap (B) allows inclination sufficient to accommodate axis displacement (A).

Sealing members 741A, 741B (such as rubber sealing) serving as the “first and second sealing members” for fluid-tight sealing of the inner circumferential surface of openings 711, 721 and the outer circumferential surface of cylindrical member 731 are adhered (for example, adhesion by vulcanization) to the outer circumferential surface of cylindrical member 731. A position of attachment of sealing member 741A, 741B is set such that the outer circumferential portion of sealing member 741A, 741B is pressed against and brought in contact with the inner circumferential surface of openings 712, 722 even when cylindrical member 731 is moved in the axial direction as far as a position where cylindrical member 731 abuts the bottom portion of opening 712, 722.

A function of the sealing structure of the casing described above will now be described. The hydraulic oil for supplying a hydraulic pressure to hydraulic pressure chamber 1068 of brake apparatus 1062 in FIG. 17 is fed through flow paths 711, 721. Flow of the hydraulic oil into between the joint surfaces of lid-like case 710B and tubular case 720B is suppressed by sealing members 741A, 741B.

In addition, when lid-like case 710B and tubular case 720B are fixed, if displacement (A) of axes from each other occurs for example due to error in working as shown in FIG. 18, cylindrical member 731 is inclined by an amount approximately the same as axis displacement (A), utilizing a gap between the outer circumferential surface of cylindrical member 731 and openings 712, 722 and gap (B) in the axial direction. Thus, even when axis displacement (A) occurs between both cases 710B and 720B, leakage of the hydraulic oil due to axis displacement (A) is suppressed by inclination of cylindrical member 731. When cylindrical member 731 is inclined, compression of sealing members 741A, 741B pressed against and coming in contact with the inner circumferential surface of opening 712, 722 becomes nonuniform. Here, the inner diameter or the like of opening 712, 722 is set such that sealing members 741A, 741B are pressed and brought in contact to such an extent that the hydraulic oil does not leak even at a position where compression of sealing members 741A, 741B caused at the time of relatively large axis displacement (A) is minimal.

In addition, for example, even when a gap (C) in the axial direction is created between lid-like case 710B and tubular case 720B due to external force, this gap (C) is always located between sealing members 741A and 741B. Therefore, sealing members 741A, 741B suppress leakage of the hydraulic oil through gap (C). It is noted that an interval between sealing members 741A and 741B is set to be sufficiently greater than a possible maximum value of gap (C). Accordingly, even if cylindrical member 731 abuts the bottom portion of opening 712, 722, gap (C) is always accommodated within the interval between sealing members 741A and 741B. Here, cylindrical member 731 can move within openings 712, 722 owing to the gap in the axial direction and in the radial direction, and fluid-tight sealing of flow paths 711, 721 with respect to axis displacement (A) of flow paths 711, 721 in various directions can be achieved. In addition, even when axis displacement (A) and creation of gap (C) in the axial direction occur in combination, regardless of axis displacement (A) and gap (C), sealing members 741A, 741B are pressed against and brought in contact with the inner circumferential surface of openings 712, 722, fluid-tight sealing of flow paths 711, 721 is achieved, and leakage of the hydraulic oil is suppressed, because the interval between sealing members 741A and 741B adhered to cylindrical member 731 is sufficiently large.

Thus, according to the sealing structure of the casing of the present embodiment, leakage of the hydraulic oil from between the joint surfaces of lid-like case 710B and tubular case 720B is suppressed by sealing members 741A, 741B and prescribed dimension error of cylindrical member 731 can be accommodated. Therefore, working of extremely high accuracy is not required, and consequently, manufacturing cost of automatic transmission 10 can be reduced.

In addition, by forming cylindrical member 731 from an elastic material in the sealing structure of the casing according to the present embodiment, dimension error of each flow path 711, 721 can be accommodated by elastic force of cylindrical member 731.

Moreover, in the sealing structure of the casing according to the present embodiment, with respect to gap (C) in the axial direction between lid-like case 710B and tubular case 720B, cylindrical member 731 slides in the axial direction within openings 712, 722 so that fluid-tightness of flow paths 711, 721 is retained. With respect to axis displacement (A) in the radial direction, cylindrical member 731 inclines so that fluid-tightness of flow paths 711, 721 is retained. Thus, leakage of a fluid from flow paths 711, 721 is suppressed by movement of cylindrical member 731 within openings 712, 722 as appropriate.

Further, in the sealing structure of the casing according to the present embodiment, as the interval between sealing members 741A and 741B is formed sufficiently greater than possible gap (C) in the axial direction, also with respect to gap (C) in the axial direction, fluid-tight sealing of flow paths 711, 721 can be attained by a pair of sealing members 741A, 741B.

In addition, in the sealing structure of the casing according to the present embodiment, as opening 712, 722 is formed by counter-boring, working is relatively easy and manufacturing cost can be reduced.

Cylindrical member 731 may be formed, for example, from aluminum in addition to the material described above, and it may be implemented by an elastic member made, for example, of a resin material or the like resistant to a fluid such as a hydraulic oil.

Moreover, sealing member 741A, 741B may be implemented by other elastic members made, for example, of a resin material.

Further, though cylindrical member 731 and sealing members 741A, 741B may be formed as separate members as described above, cylindrical member 731 and sealing members 741A, 741B may be manufactured with integral molding, for example, in such a manner that sealing members 741A, 741B are insert-molded while cylindrical member 731 is inserted in advance in a mold or cylindrical member 731 and sealing members 741A, 741B are integrally injection-molded with a resin material.

The description above is summarized as follows. Namely, in the sealing structure of the casing according to the present embodiment, sealing members 741A, 741B serving as the “sealing portion” are provided between lid-like case 710B, tubular case 720B and cylindrical member 731 serving as the “tubular member”, respectively.

In addition, in the sealing structure of the casing according to the present embodiment, the inner diameter of openings 712, 722 serving as portions receiving cylindrical member 731 in lid-like case 710B and tubular case 720B respectively is greater than the outer diameter of cylindrical member 731, and the total depth of openings 712, 722 is greater than the axial length of cylindrical member 731.

### Third Embodiment

FIG. 19 is a cross-sectional view showing a sealing structure of a casing according to a third embodiment of the present invention. Referring to FIG. 19, the sealing structure of the casing according to the present embodiment represents a variation of the sealing structure according to the second embodiment and it is provided in casing 700 of automatic transmission 1000 shown in FIG. 17, as in the second embodiment.

As shown in FIG. 19, a hole greater in diameter than flow path 711 is formed at an opening of flow path 711 formed in lid-like case 710B. In addition, a hole greater in diameter than flow path 721 and identical in diameter to the hole formed in the opening of flow path 711 is formed at an opening of flow path 721 formed in tubular case 720B. In a space in a columnar shape formed by these holes, a cylindrical member 732 having one end inserted in the hole formed in lid-like case 710B and the other end inserted in the hole formed in tubular case 720B is arranged in a manner spanning flow paths 711, 721. The holes formed in lid-like case 710B and tubular case 720B are formed, for example, by counter-boring, and have a function to prevent displacement in the axial direction of cylindrical member 732 in assembly of lid-like case 710B and tubular case 720B.

On the outer circumferential side of cylindrical member 732, an elastically deformable tubular sealing member 742 made, for example, of a rubber material, for preventing leakage of the hydraulic oil from between the joint surfaces of lid-like case 710B and tubular case 720B is provided along a peripheral wall of the holes. On the other hand, cylindrical member 732 is formed from what is called a swelling member that swells when it comes in contact with a fluid, and is formed, for example, from a water-absorbing resin composed of a cross-linked hydrophilic polymer substance such as an anionic cellulosic, starch-polyacrylamide, polyvinyl pyrrolidone, maleic acid, acrylic polymer, and the like.

Here, when the hydraulic oil is supplied to flow paths 711, 721, cylindrical member 732 which is a swelling member swells due to contact with the hydraulic oil, to expand the diameter of sealing member 742 and press the sealing member against the inner circumferential surface of the openings of flow paths 711, 721. Thus, sealing characteristics at an intimate contact portion between lid-like case 710B and tubular case 720B is improved. In addition, even if deformation in the radial direction and the axial direction due to axis displacement of flow paths 711, 721 or external force occurs, sealing member 742 is suitably deformed by cylindrical member 732 and sealing characteristics attained by sealing member 742 are retained. Here, a material for cylindrical member 732 and sealing member 742 is set such that sealing member 742 has such relative strength as deformable as a result of swelling of the cylindrical member when cylindrical member 732 swells.

As to a variation of the structure shown in FIG. 19, it is possible that cylindrical member 732 located on the inner circumferential side is implemented by a tubular rigid member formed, for example, from a metal material having relatively high rigidity such as an iron material or a copper material or a rigid resin material, while sealing member 742 located on the outer circumferential side is formed from a material similar to that for the swelling member described above.

Here, when the hydraulic oil is supplied to flow paths 711, 721, the hydraulic oil flows into the gap between the inner circumferential surface of the openings of flow paths 711, 721 and cylindrical member 732. Contact of the hydraulic oil that has flowed in with sealing member 742 causes sealing member 742 to swell in the radial direction and the axial direction. Here, as cylindrical member 732 of relatively high rigidity is arranged on the inner circumferential side of sealing member 742, the gap between the inner circumferential surface of the openings of flow paths 711, 721 and cylindrical member 732 is not varied and sealing member 742 hermetically seals the gap without clearance. Thus, sealing characteristics attained by sealing member 742 are improved and leakage of the hydraulic oil from between the joint surfaces of lid-like case 710B and tubular case 720B is prevented. In addition, even if deformation in the radial direction and the axial direction due to axis displacement of flow paths 711, 721 or external force occurs, sealing member 742 deforms in conformity with displacement or deformation. Thus, sealing characteristics attained by sealing member 742 are retained.

FIG. 20 is a cross-sectional view showing a variation of the sealing structure of the casing according to the present embodiment. Referring to FIG. 20, in the present variation, the sealing structure is formed from a wedge-shaped member 733 made, for example, of a metal material such as an iron material or a copper material and an elastically deformable tubular sealing member 743 made, for example, of a rubber material. It is noted that wedge-shaped member 733 has rigidity higher than sealing member 743.

Sealing member 743 is originally formed in a tubular shape, with its cross-section being uniform in the axial direction. Here, when wedge-shaped member 733 is inserted in sealing member 743, sealing member 743 is pressed by the outer circumferential surface of wedge-shaped member 733 in a radially outward direction and its diameter is expanded such that the sealing member comes in intimate contact with the inner circumferential surface of the openings of flow paths 711, 721. Thus, the sealing characteristics at the joint portion between lid-like case 710B and tubular case 720B are improved and leakage of the hydraulic oil from between the joint surfaces of lid-like case 710B and tubular case 720B is prevented. In addition, even if deformation in the radial direction and the axial direction due to axis displacement of flow paths 711, 721 or external force occurs, sealing member 743 deforms in conformity with displacement or deformation. Thus, sealing characteristics attained by sealing member 743 are retained.

FIG. 21 is a cross-sectional view showing another variation of the sealing structure of the casing according to the present embodiment. Referring to FIG. 21, in the present variation, the sealing structure is formed from a barrel-shaped member 734 made, for example, of a metal material such as an iron material or a copper material and an elastically deformable tubular sealing member 744 made, for example, of a rubber material.

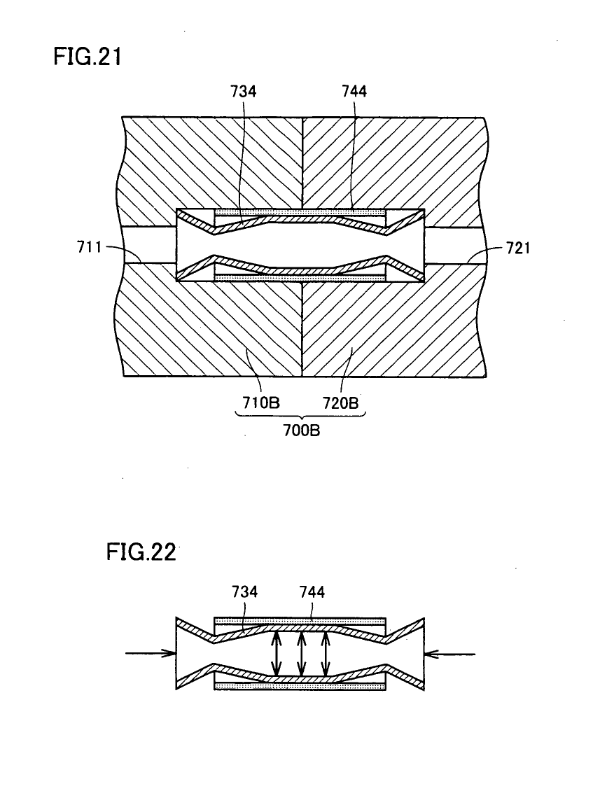

Before combining lid-like case 710B and tubular case 720B with each other, barrel-shaped member 734 is formed such that its length in the axial direction is longer than the length in the axial direction between the bottom portions of the openings formed in lid-like case 710B and tubular case 720B respectively. Here, when barrel-shaped member 734 is inserted in the openings, opposing ends of barrel-shaped member 734 abut the bottom portions of the openings and barrel-shaped member 734 is compressed in the axial direction. As shown in FIG. 22, as a result of compression force, a diameter of a central portion of barrel-shaped member 734 expands in the radially outward direction, sealing member 744 is pressed in the radially outward direction, and its diameter is expanded such that the sealing member comes in intimate contact with the inner circumferential surface of lid-like case 710B and tubular case 720B. Thus, the sealing characteristics at the joint portion between lid-like case 710B and tubular case 720B are improved and leakage of the hydraulic oil from between the joint surfaces of lid-like case 710B and tubular case 720B is prevented. In addition, even if deformation in the radial direction and the axial direction due to axis displacement of flow paths 711, 721 or external force occurs, sealing member 744 deforms in conformity with displacement or deformation. Thus, sealing characteristics attained by sealing member 744 are retained.

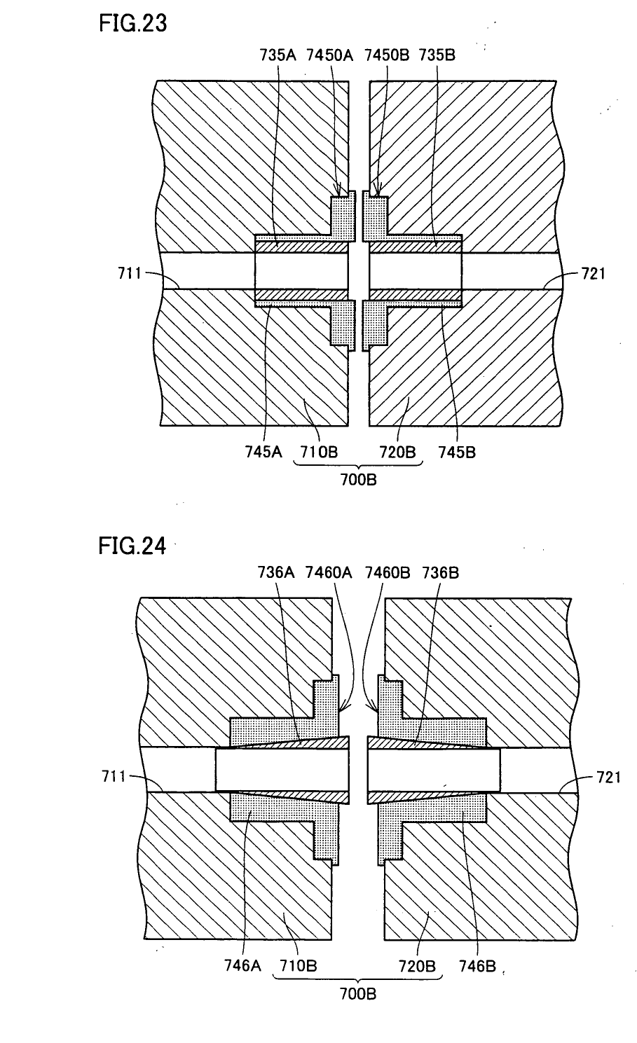

FIG. 23 is a cross-sectional view showing yet another variation of the sealing structure of the casing according to the present embodiment. FIG. 23 shows a state before combining lid-like case 710B and tubular case 720B with each other. Referring to FIG. 23, in the present variation, the sealing structure on lid-like case 710B side and the sealing structure on tubular case 720B side are formed from separate members.

The sealing structure on lid-like case 710B side is formed from a cylindrical member 735A formed from what is called a swelling member that swells when it comes in contact with a fluid, and formed, for example, from a water-absorbing resin composed of a cross-linked hydrophilic polymer substance such as an anionic cellulosic, starch-polyacrylamide, polyvinyl pyrrolidone, maleic acid, acrylic polymer, and the like, and an elastically deformable sealing member 745A made, for example, of a rubber material. In addition, the sealing structure on tubular case 720B side is formed from a cylindrical member 735B implemented, for example, by the swelling member described above and an elastically deformable sealing member 745B made, for example, of a rubber material. Sealing members 745A, 745B have flange portions 7450A, 7450B extending over the joint surfaces of lid-like case 710B and tubular case 720B respectively. As such flange portions 7450A, 7450B are provided, high sealing characteristics can be ensured even when axis displacement between flow paths 711 and 721 occurs.

Here, when the hydraulic oil is supplied to flow paths 711, 721, cylindrical members 735A, 735B that are swelling members swell due to contact with the hydraulic oil, to expand the diameter of sealing members 745A, 745B and press the sealing members against the inner circumferential surface of lid-like case 710B and tubular case 720B. Thus, sealing characteristics at an intimate contact portion between lid-like case 710B and tubular case 720B are improved. In addition, even if deformation in the radial direction and the axial direction due to axis displacement of flow paths 711, 721 or external force occurs, sealing members 745A, 745B are suitably deformed by cylindrical members 735A, 735B and sealing characteristics attained by sealing members 745A, 745B are ensured. Here, a material for cylindrical members 735A, 735B and sealing members 745A, 745B is set such that sealing members 745A, 745B have such relative strength as deformable as a result of swelling of the cylindrical members when cylindrical members 735A, 735B swell.

FIG. 24 is a cross-sectional view showing yet another variation of the sealing structure of the casing according to the present embodiment. FIG. 24 shows a state before combining lid-like case 710B and tubular case 720B with each other. Referring to FIG. 24, in the present variation, the sealing structure on lid-like case 710B side and the sealing structure on tubular case 720B side are formed from separate members.

The sealing structure on the lid-like case 710B side is formed from a wedge-shaped member 736A made, for example, of a metal material such as an iron material or a copper material and an elastically deformable tubular sealing member 746A made, for example, of a rubber material. In addition, the sealing structure on the tubular case 720B side is formed from a wedge-shaped member 736B made, for example, of a metal material such as an iron material or a copper material and an elastically deformable tubular sealing member 746B made, for example, of a rubber material. Sealing members 746A, 746B have flange portions 7460A, 7460B extending over the joint surfaces of lid-like case 710B and tubular case 720B respectively. As such flange portions 7460A, 7460B are provided, high sealing characteristics can be ensured even when axis displacement between flow paths 711 and 721 occurs. Moreover, wedge-shaped members 736A, 736B have rigidity higher than sealing members 746A, 746B.

Sealing members 746A, 746B are originally formed in a tubular shape, with its cross-section being uniform in the axial direction. Here, when wedge-shaped members 736A, 736B are inserted in sealing members 746A, 746B, sealing members 746A, 746B are pressed by the outer circumferential surface of wedge-shaped members 736A, 736B in a radially outward direction and the diameter thereof is expanded such that the sealing members come in intimate contact with the inner circumferential surface of lid-like case 710B and tubular case 720B. Thus, the sealing characteristics at the joint portion between lid-like case 710B and tubular case 720B are improved and leakage of the hydraulic oil from between the joint surfaces of lid-like case 710B and tubular case 720B is prevented. In addition, even if deformation in the radial direction and the axial direction due to axis displacement of flow paths 711, 721 or external force occurs, sealing members 746A, 746B deform in conformity with displacement or deformation. Thus, sealing characteristics attained by sealing members 746A, 746B are retained.

As the structures shown in FIGS. 19 to 24 do not require high working accuracy and manufacturing is easy, manufacturing cost can be suppressed.

It is noted that the concept of the present invention is applicable also to embodiments other than those described above. For example, flow paths 711, 721 are not limited to a passage for a coolant or a flow path for hydraulic oil supply, and the present invention is applicable to any flow path for communication between different members. In addition, a liquid that flows through the flow path is not limited to water or oil, and the present invention is applicable to other fluids. In that case, a material suitable for that fluid is selected for a swelling member.

In addition, in the examples above, cylindrical members 732, 735A, 735B, wedge-shaped members 733, 736A, 736B, and barrel-shaped member 734 are formed separately from sealing members 742 to 744, 745A, 745B, 746A, 746B, however, these members may be formed as one piece by adhesion or the like before combination of lid-like case 710B and tubular case 720B with each other.

Moreover, for example, a synthetic resin or the like may be used instead of a rubber material described above. Further, though the wedge-shaped member and the barrel-shaped member are used as the expanding member in the examples above, the expanding member is not limited as such and any member generating force in a radial direction such as a snap ring formed in a tubular shape may freely be used as the expanding member.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The present invention is applicable, for example, to a sealing structure of a casing in a powertrain and the like.

1. A sealing structure of a casing, comprising:
a first case forming member having a first fluid path;
a second case forming member having a second fluid path communicating with said first fluid path when combined with said first case forming member;
a tubular member provided to fit to said first and second case forming members and surround said first and second fluid paths at a joint portion between said first and second case forming members; and
a sealing portion provided on an outer circumferential side of said tubular member.

2. The sealing structure of a casing according to claim 1, wherein
said tubular member includes a member fitted to both of said first and second case forming members.

3. The sealing structure of a casing according to claim 1, wherein
said sealing portion is provided in contact with the outer circumferential surface of said tubular member.

4. The sealing structure of a casing according to claim 3, wherein
a recess portion is formed as a result of back-off of at least one of joint surfaces of said first and second case forming members at a position adjacent to the outer circumferential surface of said tubular member, and
said sealing portion is provided in said recess portion.

5. The sealing structure of a casing according to claim 1, wherein
said sealing portion includes an O-ring or a liquid gasket.

6. The sealing structure of a casing according to claim 1, wherein
said sealing portion includes first and second sealing members provided between said first and second case forming members and said tubular member, respectively.

7. The sealing structure of a casing according to claim 1, wherein
a portion receiving said tubular member in said first and second case forming members has an inner diameter larger than an outer diameter of said tubular member, and
total depth of the portion receiving said tubular member in said first and second case forming members is greater than an axial length of said tubular member.

8. The sealing structure of a casing according to claim 1, wherein
said tubular member or said sealing portion swells as a result of contact with a fluid that flows through said first and second fluid paths.

9. The sealing structure of a casing according to claim 1, wherein
said tubular member expands said sealing portion in a radial direction as a result of being fitted inside of said sealing portion.
